(19) United States
(12) Patent Application Publication
(10) Pub. No.: US 2024/0055640 A1
(43) Pub. Date: Feb. 15, 2024

(54) BACKBONE-STRUCTURED METAL-SUPPORTED ELECTROCHEMICAL CELL

(71) Applicant: Precision Combustion, Inc., North Haven, CT (US)

(72) Inventors: Toshio Suzuki, New Haven, CT (US); Timothy LaBreche, Woodbridge, CT (US); Christian Junaedi, Cheshire, CT (US); Subir Roychoudhury, Madison, CT (US)

(21) Appl. No.: 18/547,203

(22) PCT Filed: Mar. 4, 2022
(86) PCT No.: PCT/US22/18913

§ 371 Date: Aug. 21, 2023

Related U.S. Application Data
(60) Provisional application No. 63/160,200, filed on Mar. 12, 2021.

(51) Int. Cl. H01M 8/1226; H01M 8/1286; H01M 8/0273; H01M 8/0258; H01M 8/2425; C25B 9/19; C25B 13/07; B41M 5/00; B22F 3/10; B22F 3/14; B22F 7/00

(52) U.S. Cl. CPC H01M 8/1226; H01M 8/1286; H01M 8/0273; H01M 8/0258; H01M 8/2425; C25B 9/19; C25B 13/07; B41M 5/0058; B22F 3/1007; B22F 3/14; B22F 7/004; H01M 2008/1293

(57) ABSTRACT

This invention pertains to a reinforced porous metal substrate that finds utility in a backbone-structured metal-supported electrochemical cell and to methods of fabricating the reinforced porous metal substrate. In another aspect, this invention pertains to a backbone-structured metal-supported electrochemical cell repeat unit constructed by weld sealing or diffusion bonding the reinforced porous metal substrate to a metal frame. In another aspect, this invention pertains to an electrochemical cell and stack.

### CROSS-REFERENCE TO RELATED APPLICATIONS

This application claims benefit of U.S. provisional application No. 63/160,200, filed Mar. 12, 2021, contents of which are incorporated herein by reference.

### GOVERNMENT RIGHTS

This invention was made with U.S. Government support under contract no. W911NF19P0036, sponsored by the Department of Defense. The U.S. Government has certain rights in this invention.

### FIELD OF THE INVENTION

In one aspect, this invention pertains to a reinforced porous metal substrate that finds utility in a metal-supported electrochemical cell, such as, a metal-supported solid oxide fuel cell (MS-SOFC) or a metal-supported solid oxide electrolysis cell (MS-SOEC). This invention also pertains to methods of fabricating the reinforced porous metal substrate. In yet another aspect, this invention pertains to a backbone-structured electrochemical cell. In another aspect, this invention pertains to an electrochemical cell stack fabricated with a plurality of electrochemical cell repeat units.

### BACKGROUND OF THE INVENTION

An electrochemical cell is comprised of three essential components disposed in a layered (sandwich) configuration: an oxygen electrode, an electrolyte, and a fuel electrode. More specifically, in a solid oxide fuel cell (SOFC) the components include the oxygen electrode functioning to reduce molecular oxygen with a source of electrons to oxide ions; an electrolyte middle layer functioning as a medium to transport the oxide ions from the oxygen electrode to the fuel electrode; and the fuel electrode functioning to oxidize a fuel, such as hydrogen, carbon monoxide or a mixture thereof, with the oxide ions to produce water and carbon dioxide, respectively, with concomitant production of electrons. The electrodes are connected via an external electrical circuit, such that the electrons produced at the fuel electrode traverse the external circuit to the oxygen electrode while being available for useful electrical work. The voltage achieved from one electrochemical cell is typically small; therefore, a plurality of such individual cells incorporated with interconnects, gas flow channels, and optionally other components, are connected in series or parallel to form a cell stack of higher voltage and power output. The individual cell that is multiplied to form the stack is referenced herein as an “electrochemical cell repeat unit”.

In order to provide structure and strength to an electrochemical cell, the art discloses use of a porous metal substrate to support cell components comprising the fuel electrode, the electrolyte, and the oxygen electrode. An electrochemical cell where the cell components are adjoined to a porous metal substrate is referred to herein as “metal-supported”, as in the MS-SOFC. Conventional joining together of a collection of electrochemical cell repeat units to form a stack presents construction problems due to potential sealing issues, non-uniform compression, and mismatch in coefficients of thermal expansion (CTE) between materials. Weld sealing or diffusion bonding could provide many benefits for stack assembly, namely, a reduction in gaskets and glass seals for realization of a lighter stack having a higher power output and for improved seal and thermal cycling durability throughout all operation profiles. Disadvantageously, weld sealing or diffusion bonding cannot be employed with the porous metal substrate. Due to its high porosity, the porous metal substrate is prone to cave in and deformation during the welding process.

In view of the above, it would be desirable to design a metal-supported electrochemical cell that is amenable to weld sealing or diffusion bonding, so that a plurality of electrochemical cell repeat units could be assembled into a stack having improved strength, durability and robustness over a full range of operating conditions.

### SUMMARY OF THE INVENTION

We have invented a novel metal-supported electrochemical cell incorporating a porous metal substrate that enables weld sealing or diffusion bonding for stack assemblies. The novel metal-supported electrochemical cell comprises an extra layer of metal strip, hereinafter referred to as a “metal reinforcement member”, disposed on a perimeter of the porous metal substrate. The metal reinforcement member functions, advantageously, as a diffusion bonding layer to provide edge densification so as to structure the cell for better weldability. Application of weld sealing or diffusion bonding provides for fabrication of a backbone-structured electrochemical cell; and more particularly to realization of a lighter electrochemical cell-based stack assembly, thereby resulting in a higher specific power (higher kW/kg). The sealing configuration also results in improved durability and improved thermal cycling capability through all operating profiles. Moreover, the edge-densified metal substrate and resulting backbone-structured electrochemical cell of this invention, constructed in accordance with the weld or diffusion seal design described hereinafter, provide for improved vibration resistance and tolerance through start up and transient thermal cycling.

Accordingly, in one aspect, this invention provides for a novel reinforced porous metal substrate for use in an electrochemical cell, comprising: (a) a metal substrate configured as a layer defining a first side and a second side and having a porosity ranging from about 20 volume percent to 50 volume percent, and (b) a densified metal reinforcement member disposed along at least a portion of a perimeter of one side of the porous metal substrate. The densified metal reinforcement member functions to add strength to the porous metal substrate while providing a site for welding or diffusion bonding. Advantageously, with the addition of the metal reinforcement member, the substrate is resistant to cave-in, damage and deformation during fabrication and during the welding or bonding process to construct the stack. The novel reinforced porous metal substrate of this invention finds utility in fabricating a metal-supported electrochemical cell repeat unit, wherein each repeat unit is constructed by welding or diffusion bonding components at the metal reinforcement member.

In another aspect, this invention pertains to a backbone-structured metal-supported electrochemical cell comprising a layered configuration of the following components:
(a) an oxygen electrode,
(b) an electrolyte,
(c) a fuel electrode,
(d) a porous metal substrate configured as a layer defining a first side and a second side and having a porosity ranging from about 20 volume percent to 50 volume percent, the first side being disposed adjacent the fuel electrode, and
(e) a densified metal reinforcement member disposed along at least a portion of a perimeter of the second side of the porous metal substrate.

In one illustrative embodiment, the metal-supported electrochemical cell further comprises an interlayer disposed in between (a) the oxygen electrode and (b) the electrolyte.

In another illustrative embodiment, the metal-supported electrochemical cell further comprises a barrier layer disposed in between (c) the fuel electrode and (d) the porous metal substrate.

In yet another illustrative embodiment, the metal-supported electrochemical cell comprises an additional layer in the form of (f) a metal frame coupled to (e) the densified metal reinforcement member, the metal frame configured with one or more gas flow channels.

This invention also provides for a metal-supported electrochemical cell repeat unit comprising layers (a) through (f) defined hereinabove and further comprising an additional layer in the form of (g) an interconnect coupled to (f) the metal frame. In another embodiment, the interconnect is configured with a plurality of fuel gas flow channels disposed on a first side (top side) of the interconnect coupled to the metal frame. In yet another embodiment, the interconnect is configured with a plurality of oxygen (or air) flow channels disposed on a second side (bottom side) of the interconnect opposite the first side (top side) coupled to the metal frame. After the metal-supported electrochemical cell is configured with the metal frame, interconnect and flow channels, the cell is suitable for assembly into a stack; and in this configuration each individual cell is defined herein as a “metal-supported electrochemical cell repeat unit”.

In another embodiment, the aforementioned metal-supported electrochemical cell repeat unit may comprise additional layered components, such as a non-conductive gasket, a metal mesh current collector, or a combination thereof, these being disposed on the second side (bottom side) of the interconnect opposite the first side coupled to the metal frame.

In another aspect, this invention provides for a backbone-structured electrochemical cell stack, such as a backbone-structured MS-SOFC stack, comprised of a plurality of the aforementioned metal-supported electrochemical cell repeat units; wherein each repeat unit comprises the cell (layered oxygen electrode, electrolyte, fuel electrode, porous metal substrate, and reinforcement member), metal frame, and interconnect including gas flow channels. Accordingly, the stack is assembled through a plurality of aforementioned metal-supported electrochemical cell repeat units realized by the densified metal reinforcement members.

In another aspect, this invention pertains to a first method of making the reinforced porous metal substrate comprising:
(a) screen printing a metal reinforcement ink along at least a portion of a perimeter of one side of a layer of porous metal substrate having a porosity ranging from about 20 volume percent to 50 volume percent so as to form a substrate-ink composite;
(b) sintering the substrate-ink composite under conditions sufficient to prepare a densified metal-reinforcement member, so as to obtain the reinforced porous metal substrate configured as a layer defining a first side and a second side, and having a porosity ranging from about 20 volume percent to 50 volume percent and having disposed along at least a portion of a perimeter of one side thereof the densified metal reinforcement member.

In another aspect, this invention pertains to a second method of making the reinforced porous metal substrate comprising:
(a) providing a green metal sheet comprising metal substrate particles and a pore former capable of producing a porosity ranging from about 20 volume percent to 50 volume percent; and providing a green metal reinforcement member comprising metal particles of a reinforcement member;
(b) hot pressing the green metal reinforcement member onto at least a portion of a perimeter of one side of the green metal sheet to form a laminated structure;
(c) sintering the laminated structure under conditions sufficient to prepare the reinforced porous metal substrate, comprising a porous metal substrate configured as a layer defining a first side and a second side, and having a porosity ranging from about 20 volume percent to 50 volume percent and having disposed along at least a portion of a perimeter of one side thereof the densified metal reinforcement member.

Utilizing the metal-reinforced porous metal substrate of this invention, that is, the edge-densified substrate, in an electrochemical cell provides for novel fabrication methods of repeat unit and stack assembly. Advantageously, this invention enables elimination of ceramic and glass seals by bonding the porous metal substrate to a metal reinforcement member, which functions as a welding and diffusion bonding site. This approach reduces the number of components required for assembling cells into stacks resulting in lower overall stack weight and increased power density (kW/kg). Welding or diffusion bonding the metal-supported cells together with other stack components also improves durability of the stack and prevents leaks and degradation associated with thermal cycling.

### BRIEF DESCRIPTION OF THE DRAWINGS

FIG. 1 illustrates in transverse view an embodiment of this invention wherein a single electrochemical cell employs cell components supported on the reinforced porous metal substrate of this invention.

FIG. 2 depicts the embodiment of FIG. 1 viewed from the bottom of the electrochemical cell towards the reinforced porous metal substrate.

FIG. 3 depicts in transverse view another embodiment of this invention wherein a single electrochemical cell is supported on the reinforced porous metal substrate of this invention.

FIG. 4 depicts in transverse view another embodiment of this invention wherein a single electrochemical cell is supported on the reinforced porous metal substrate of this invention.

FIG. 5 depicts the lamination process of this invention resulting in an embodiment of a perimeter-reinforced metal-supported solid oxide fuel cell of this invention.

FIG. 6 illustrates in isometric view an embodiment of a perimeter-reinforced metal-supported solid oxide fuel cell repeat unit of this invention, viewed towards the fuel manifold side of the interconnect.

FIG. 7 illustrates in isometric view an embodiment of a perimeter-reinforced metal-supported solid oxide fuel cell repeat unit of this invention, viewed towards the air manifold side of the interconnect.

### DETAILED DESCRIPTION OF THE INVENTION

As used herein, the word “layer” refers to a quasi-two-dimensional structure wherein dimensions of length and width are significantly larger than dimension of thickness. A layer can be considered a plane or sheet defining two main parallel sides, hereinafter a “first side” (e.g., top side) and a “second side” (e.g., bottom side). A layer of one thickness of a first material typically covers all or a portion of a surface or layer of a second material. The term as used herein does not limit the layer to any particular shape. The layer can be in the form of a square, rectangle, hexagon, circle, ellipse, or any other shape as dictated by design. Generally, all layers in the electrochemical cell described herein have the same shape so that they can be matched, sealed, and secured on edges and corners. For purposes of this invention, the layer of the first material is not required to cover the entire surface of the second material. Since components in this invention are disposed in a stacked or sandwich configuration, the description is simplified by referring to each component as a “layer” whether or not the component covers the entire surface of the adjoining component.

To be more specific, the reinforcement member is described herein to be a “layer” although it is required to cover only at least a portion of the perimeter of the porous metal substrate.

The term “perimeter”, as used herein, takes its typical mathematical meaning, referring to a continuous line that defines the boundaries of an object. In this case, the term “perimeter” refers most often to the boundaries of the layer of the porous metal substrate.

Likewise, the term “edge”, as used herein, refers to the outside limit of an object, area, or surface; a place or part farthest away from the center. Accordingly, the edge of the object falls along its perimeter. For the purposes of this invention, the terms “perimeter” and “edge” are used interchangeably. In actuality, the “perimeter” or “edge” of a layer, for example, the porous metal substrate layer, will have a measurable width, typically referring to a strip having a width from about 1 mm to about 5 mm, although more than 5 mm can still be considered the perimeter or edge for a larger cell (such as 10 cm×10 cm cell or larger). This range correlates roughly to a width of perimeter strip ranging from about 1 percent to 20 percent of the full length or width dimension of the layer.

As used herein, the term “porosity” refers to void space or interstices within a solid material, herein, a layer. Porosity is measured as a fraction or percentage of void volume as compared with a total volume occupied by the solid material.

The term “welding” or “welded” or “weld sealing” as used herein refers to a fabrication process that joins materials, such as metals, by employing high heat to melt the parts together, then allowing them to cool causing fusion.

The term “diffusion bonding” as used herein refers to a welding technique for joining similar and dissimilar metals. Diffusion bonding operates on a principle of solid-state diffusion wherein atoms of two solid, metallic surfaces intersperse themselves over time. This is typically accomplished at an elevated temperature, approximately 50 to 75 percent of the absolute melting temperatures of the materials, and is usually implemented by applying pressure in conjunction with high temperature.

As exemplified herein, the densified metal reinforcement member within the electrochemical cell provides for a structural element, namely, a backbone element that offers strength, weldability and durability to the electrochemical cell repeat unit. The plurality of repeat units comprised of densified metal reinforcement members within the electrochemical cell stack is referred to herein as the “backbone-structured” cell stack.

Where a range is set forth herein, the word “about” is placed before the lower limit of the range. Unless otherwise noted, the word “about” is intended to modify both the lower and upper limits of the range allowing for an acceptable variance in both lower and upper limits.

In one illustrative embodiment, this invention provides for a novel reinforced porous metal substrate for use in an electrochemical cell, comprising: (a) a metal substrate configured as a layer defining a first side and a second side and having a porosity ranging from about 20 volume percent to 50 volume percent; and (b) a densified metal reinforcement member having a porosity less 20 volume percent and being disposed along at least a portion of a perimeter of one side of the porous metal substrate.

In another illustrative embodiment, this invention provides for a backbone-structured metal-supported electrochemical cell comprising a layered configuration of the following components:
(a) an oxygen electrode,
(b) an electrolyte,
(c) a fuel electrode,
(d) a porous metal substrate configured as a layer defining a first side and a second
side, and having a porosity ranging from about 20 volume percent to 50 volume percent, the first side being disposed adjacent the fuel electrode, and
(e) a densified metal reinforcement member having a porosity less than 20 volume percent, the member being disposed along at least a portion of a perimeter of the second side of the porous metal substrate.

In a further illustrative example of any of the aforementioned embodiments the pore size of the porous metal substrate ranges from about 3 microns to 75 microns.

In yet a further illustrative example of the aforementioned embodiments, the porous metal substrate has a thickness ranging from about 80 microns to 1,000 microns.

In yet a further illustrative example of any of the aforementioned embodiments, the densified reinforcement member has a thickness ranging from about 50 microns to 1,000 microns.

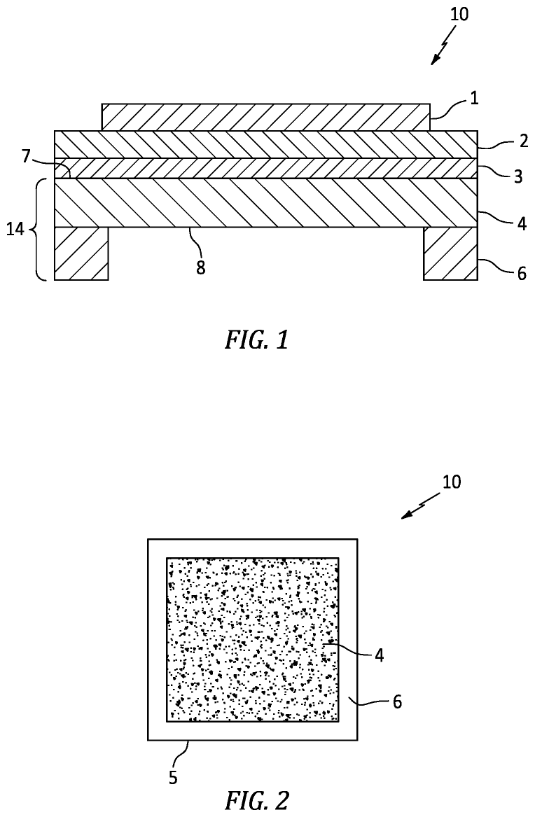

This invention and its various embodiments are better envisioned and understood from a description of the Drawings attached hereto. FIG. 1 illustrates in transverse view an embodiment of this invention comprising a single individual electrochemical cell supported on a porous metal substrate coupled to a metal reinforcement member for welding or diffusion bonding purposes. As seen in FIG. 1, electrochemical cell 10 is depicted in a layered (or sandwich) configuration of the following cell components: an oxygen electrode 1 (alternatively, referenced as a “cathode”), an electrolyte 2, and a fuel electrode 3 (alternatively, referenced as an “anode”). The fuel electrode 3 is applied to and supported on reinforced (edge-densified) porous metal substrate 14 consisting of a porous metal substrate layer 4, which on its bottom side 8 is coupled along its perimeter to metal reinforcement member 6. A top side 7 of the porous metal substrate layer 4 is disposed adjacent to the fuel electrode 3. For clarification, FIG. 2 is provided illustrating electrochemical cell 10 as viewed from the bottom of the cell, towards the porous metal substrate 4, as shown with reinforcement member 6 disposed around perimeter 5.

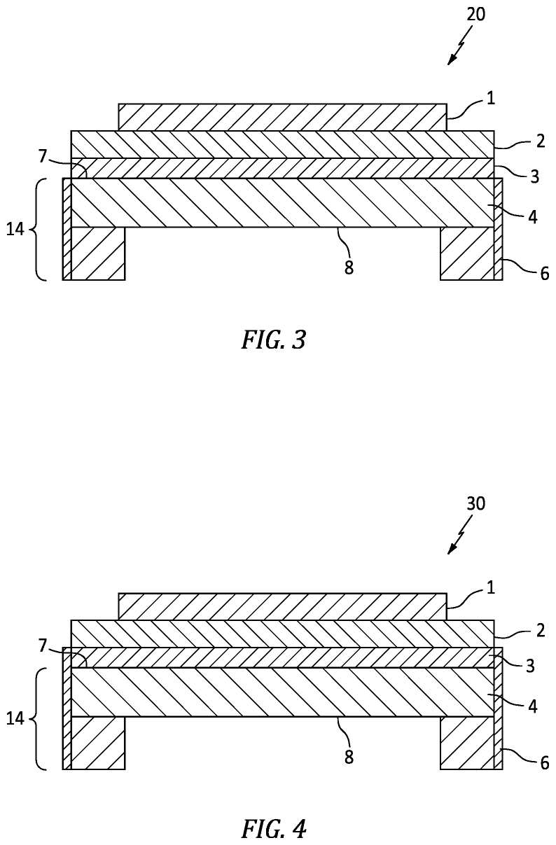

FIG. 3 depicts in transverse view another embodiment of this invention 20 wherein the electrochemical cell is configured similarly in a layered configuration of the following cell components: an oxygen electrode 1, an electrolyte 2, and a fuel electrode 3. The fuel electrode 3 is again applied to and supported on reinforced (edge-densified) porous metal substrate 14 consisting of porous metal substrate layer 4, which on its bottom side 8 is coupled along its perimeter to metal reinforcement member 6. In embodiment 20, the metal reinforcement member 6 extends along the side edges of the porous metal substrate 4.

FIG. 4 depicts in transverse view another embodiment of this invention 30 wherein electrochemical cell is configured similarly in a layered configuration of the following cell components: an oxygen electrode 1, an electrolyte 2, and a fuel electrode 3. The fuel electrode 3 is again applied to and supported on reinforced (edge-densified) porous metal substrate 14 consisting of a porous metal substrate layer 4, which on its bottom side 8 is coupled along its perimeter to metal reinforcement member 6. In this embodiment, the metal reinforcement member 6 extends along the side edges of porous metal substrate 4 and additionally along the side edges of fuel electrode 3. In yet another embodiment (not shown), the metal reinforcement member 6 extends along the side edges of porous metal substrate 4 and additionally along the side edges of fuel electrode 3 and electrolyte 2.

Generally the metal substrate comprises any metallic material, such as a pure metallic element or a combination of metallic elements as in an alloy. Non-limiting examples of suitable metal substrates include ferritic and austenitic alloys predominantly comprising iron and amounts of chromium ranging from about 10 wt. percent to 40 wt. percent, as well as smaller amounts of optional metallic elements selected from the group consisting of yttrium, manganese, nickel, niobium, aluminum, lanthanum, molybdenum and mixtures thereof. Yttrium is suitably provided in an amount ranging from 0 to 30 wt. percent. Such alloys may also include small amounts of carbon in a range from about 0.03 to about 0.16 wt. percent. In one embodiment, the porous metal substrate comprises a ferritic alloy; in another embodiment, a ferritic iron-chromium alloy. Other suitable porous metal substrates include iron-nickel-chromium alloys, iron-cobalt alloys, iron-aluminum-chromium alloys, and chromium alloys.

The metal substrate is required to be “porous” meaning that a plurality of pores, channels, and/or open spaces are present throughout and within the substrate so as to facilitate diffusion of gaseous components there through. Typically, the metal substrate has pores ranging in size from about 3 microns to 75 microns in diameter or critical dimension. Typically, the porosity of the metal substrate ranges from about 20 to about 50 volume percent, based on the total volume of the porous metal substrate. The metal substrate is formed into a layer having a thickness ranging from about 80 microns (0.08 mm) to about 1,000 microns (1 mm), preferably, from about 100 microns (0.1 mm) to about 500 microns (0.5 mm).

The densified metal reinforcement member is constructed of any metallic element or alloy that provides the necessary strength, weldability, and durability to the electrochemical cell under fabrication and operating conditions. Specifically, the reinforcement member comprises a metallic material, such as a pure metallic element or a combination of metallic elements as in an alloy. In one illustrative embodiment, the reinforcement member is a metallic element or alloy identical in composition to that of the porous metal substrate. In another illustrative embodiment, the reinforcement member is a metallic element or alloy different in composition from that of the porous metal substrate. Non-limiting examples of suitable metal reinforcement materials include ferritic and austenitic alloys, preferably ferritic, which alloys predominantly comprising iron and amounts of chromium ranging from about 10 wt. percent to 40 wt. percent; and may optionally contain smaller amounts of other metallic elements selected from the group consisting of yttrium, manganese, nickel, niobium, aluminum, lanthanum, molybdenum and mixtures thereof. Such alloys can also include small amounts of carbon in a range from about 0.03 to about 0.16 wt. percent. Other suitable reinforcement materials include iron-nickel-chromium alloys, iron-cobalt alloys, iron-aluminum-chromium alloys, and chromium alloys.

Generally the metal reinforcement member has a lower porosity providing for a denser (“densified”) material as compared to that of the porous metal substrate. In one embodiment the reinforcement member has a porosity of less than about 20 vol. percent, based on the density of the material from which the reinforcement member is constructed. The reinforcement member typically has a thickness (or height) ranging from about 50 microns (0.05 mm) to about 1,000 microns (1 mm), preferably, from about 200 microns (0.2 mm) to about 700 microns (0.7 mm).

As seen in FIGS. 1 and 2, the metal reinforcement member 6 is configured as a frame along the entire edge or perimeter 5 of porous metal substrate 4, more particularly, along the edge of bottom side 8 of the porous metal substrate 4, opposite the top side 7 coupled to fuel electrode (anode) 3. In an alternative embodiment, the metal reinforcement member further comprises reinforcement struts disposed across surface 8 of porous metal substrate 4, so as to provide additional strength and support. For example, struts in the form of a cross or any other geometric design can be secured on or across side 8 of the porous metal substrate 4 to supplement the perimeter reinforcement 6. In another illustrative example, the reinforcement member 6 is disposed on two parallel edges, but not the entire perimeter, of the bottom side 8 of the porous metal substrate 4. In another illustrative example, the reinforcement member 6 is disposed on four corners, but not the entire perimeter, of the bottom side 8 of the porous metal substrate 4. The metal reinforcement member 6 functions to provide a backbone welding site for constructing the stack assembly.

Any method known in the art can be employed to couple the metal reinforcement member to the porous metal substrate, provided that the method does not cause the porous metal substrate to sustain unacceptable deformation or damage. For fabrication of the reinforced porous metal substrate, two process routes were developed, namely, (a) casted tape lamination, and (b) metal ink printing.

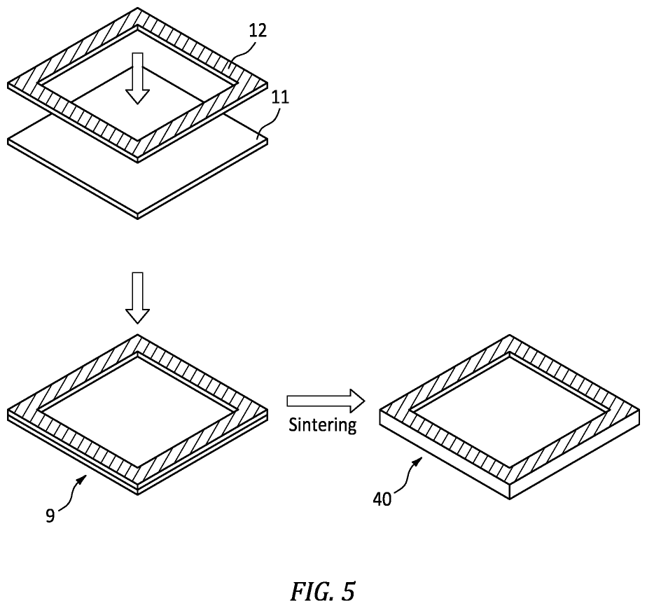

FIG. 5 illustrates the process of casted tape lamination. In this process a green reinforcement layer 12, provided as a frame of thin green tape, is laminated onto the perimeter edge of the bottom side of a green porous metal sheet 11 comprising a precursor to the porous metal substrate. The green sheets can be obtained from a commercial green tape fabricator using powder particles of the selected metal for the substrate, a selected pore former capable of providing a selected porosity and pore size within the metal substrate, and the selected reinforcement metal(s) as desired. The lamination is effected by hot pressing, represented in FIG. 5 by application of pressure (vertical arrow) and heating. Hot pressing conditions typically include a pressure ranging from about 30 lbs/sq in (30 psi, 206.8 kPa) to about 500 psi (3,447 kPa) at a temperature ranging from about 50° C. to about 150° C. Thereafter, the resulting laminated structure 9 is co-sintered under a reducing atmosphere, such as a mixture of hydrogen and an inert (non-reactive) gas at a temperature sufficient to form the reinforced porous metal substrate 40 having the metal-reinforced densified edge. In one embodiment, the reducing atmosphere comprises from about 1 to about 20 volume percent (20 vol. %) hydrogen in inert gas, such as nitrogen or argon. An acceptable sintering process involves raising temperature from ambient to a temperature between about 900° C. and 1300° C. One or more laminated layers can be applied as desired until the selected reinforcement thickness is achieved. In one embodiment prepared by this lamination method, the resulting reinforced porous metal substrate comprised a metal substrate having a thickness of 0.27 mm coupled to a metal reinforcement member having a thickness of 0.47 mm.

Laminated layers form thicker layers suitable for welding. They also reinforce the edge of the substrate to improve its flatness. An acceptable flatness is important for maintaining good cell component printing quality. An advantage of this invention involves fabrication of substantially flat layers, which also allows for a secure and tight-fitting application of an electrode layer thereupon. The term “flat” refers to a level surface characterized by lines or tracings substantially without peaks and valleys. An acceptable level of flatness can be determined by visual inspection of the layer for warpage by using an optical microscope of about 10 to 20 times magnification.

The second fabrication method for making the reinforced porous metal substrate involves preparing a metal reinforcement ink that is screen printed onto the perimeter of the porous metal substrate, after which the resulting substrate-ink composite is sintered. Typically, the metal reinforcement ink comprises a mixture of a solvent, a binder, particles of the metal reinforcement composition, and optionally, one or more of a plasticizer and a dispersant. The solvent employed in the ink is typically selected from common organic solvents that are easily volatilized. Such solvents are generally selected from the group consisting of alcohols, esters, and ketones and are typically supplied in an amount ranging from about 5 to 30 weight percent, based on the total weight of the metal reinforcement material. The binder is selected from commercial binder formulations including, for example, a compound of the cellulose family, such as the non-limiting example of ethyl cellulose. The binder is provided in an amount ranging from about 5 to 30 wt. percent, based on the total weight of the metal reinforcement material. The metal particles of the reinforcement material are typically provided in an average particle size ranging from about 5 microns to about 25 microns. Suitable plasticizers include phthalate and glycol groups, added typically in an amount ranging from about 1 wt. percent to about 20 wt. percent, again based on the total weight of the metal reinforcement material. Suitable dispersants include fish oil and amine group dispersants provided in an amount ranging from about 1 wt. percent to about 20 wt. percent, based on the total weight of the metal reinforcement material. Thickness is optimized by controlling the ink's solid load and the number of coatings, as dictated by the desired weldability. Sintering is effected under a reducing atmosphere comprising, for example, a mixture of hydrogen and an inert gas, such as nitrogen or argon. In one embodiment, the reducing atmosphere comprises about 1 to 20 vol. percent hydrogen in inert gas. An acceptable sintering process involves raising the temperature from ambient to between about 900° C. and 1300° C.

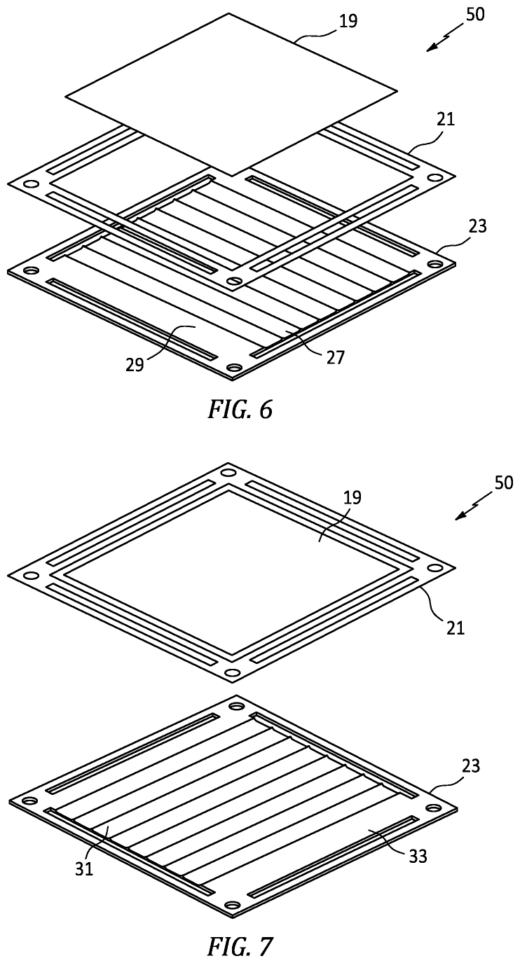

FIG. 6 illustrates in isometric view a metal-supported solid oxide fuel cell repeat unit 50, useful for a stack design, consisting of a MS-SOFC 19, which should be understood to comprise a multi-layered metal-supported electrochemical cell as exemplified, for example, in FIGS. 1, 3 and 4. The reinforcement member 6 of MS-SOFC 19 allows for welding the cell 19 to an additional layer comprising metal frame 21 (also referenced herein as a “metal spacer”). Metal frame 21 typically comprises channels for access and egress of gaseous flows. Further to FIG. 6, metal frame 21 is coupled to an additional layer comprising a metal interconnect 23. On top side 29 of interconnect 23, facing reinforcement member 6 and fuel electrode 3 (as seen, e.g., in detail in FIG. 1), interconnect 23 is structured with a plurality of fuel gas flow channels 27, providing for a flow of fuel, typically hydrogen, carbon monoxide, or a mixture thereof, to be fed to the fuel electrode of the fuel cell 19.

FIG. 7 depicts in isometric view a MS-SOFC embodiment 50 of the invention on rotating 180 degrees the repeat unit shown in FIG. 6 on its horizontal axis, thereby illustrating the bottom side 33 of interconnect 23. On bottom side 33, interconnect 23 is coupled to frame 21 and faces an oxygen electrode of an adjoining MS-SOFC 19. Thus, interconnect 23 is designed with air flow channels 31 for feeding air, diluted oxygen or pure oxygen to the oxygen electrode (FIG. 1/1) of the fuel cell.

As a technical advantage, the MS-SOFC repeat unit, enabled by our novel perimeter metal reinforcement approach, provides for robustness with regard to vibration resistance and thermal cycling and rapid start-up. Welding allows for a gas tight seal. No gasket or glass seal is required. The MS-SOFC 19 has been structured onto the metal frame 21 by welding at the metal reinforcement member 6 (FIG. 1).

This invention is not limited to use of any specific fuel electrode, electrolyte, or oxygen electrode. The fuel electrode is assembled with fuel gas flow channels to allow the fuel, typically a gaseous reformate comprising hydrogen and carbon monoxide, to flow uniformly throughout from inlet to outlet. Since the fuel electrode must be electrically and ionically conductive, the fuel electrode typically comprises a cermet combination of ceramic and metal prepared by standard ceramic processing techniques. Non-limiting examples of cermets useful as the fuel electrode layer include a composite comprising nickel or nickel oxide combined with a metal oxide wherein the metal is selected from the group consisting of zirconium, yttrium, cerium, scandium, gadolinium, samarium, calcium, lanthanum, strontium, magnesium, gallium, barium, and mixtures thereof. Some non-limiting illustrative embodiments include: nickel-yttria stabilized zirconia, nickel mixed with gadolinium doped ceria, and nickel mixed with yttria doped ceria zirconia.

The solid oxide electrolyte comprises a dense layer of ceramic that conducts oxide ions (O²⁻). As examples of a material from which the solid oxide electrolyte layer can be made, we include yttria-stabilized zirconia (YSZ), scandia-stabilized zirconia (ScSZ), and gadolinium-stabilized ceria (GDC), as well as ceria-based electrolytes. As newer electrolytes are developed, these may lead to less resistivity problems and, if applicable, improved conductivity of oxide ions, which in turn may lead to more robust and better performing electrolyte layers, any of which may be employed in this invention.

The oxygen electrode should also be porous so as to provide for a uniform flow of oxygen throughout the electrode and should be capable of conducting oxide ions (O²⁻) to the solid oxide electrolyte. As non-limiting examples of a material from which the oxygen electrode can be formed, we include those of formula ABO₃, wherein A is selected from the group consisting of barium, strontium, lanthanum, samarium, praseodymium, and combinations thereof, and B is selected from the group consisting of iron, cobalt, nickel, manganese, and mixtures thereof. Some illustrative embodiments include manganese-modified-yttria-stabilized zirconia, lanthanum strontium manganite, lanthanum strontium ferrite and any of the cobaltites.

The metal frame generally has the same description as the metal reinforcement member in terms of material of construction, density, strength and thickness. The metal frame is welded to the metal reinforcement member. The welding process advantageously is effected without damage to the porous metal substrate supporting the electrode, in one embodiment the fuel electrode.

The interconnect provides another layer welded to the metal frame on a bottom side of the frame, opposite the top side coupled to the metal reinforcement member. Since the interconnect is exposed at high temperatures to both oxidizing and reducing sides of the fuel cell, the interconnect should be stable under both circumstances. Accordingly, the interconnect is comprised of an electrically conductive material that is able to withstand the thermal and chemical environments to which it is exposed. In one embodiment, the interconnect is constructed of a metallic plate or foil, for example, high temperature stainless steel, such as an iron chromium (FeCr) alloy or a nickel chromium (NiCr) alloy. This invention is not limited to any particular interconnect thickness and material. In one embodiment, optionally, the interconnect on the side facing the metal frame is featured with fuel gas flow channels to provide for fuel gas flow to the fuel electrode; whilst on the opposite side the interconnect is featured with oxygen or air flow channels to provide for oxygen or air flow to the oxygen electrode.

The optional layers are not limited and generally of conventional composition. The interlayer, for example, may be a composition of doped ceria (dopant selected from Gd, Sm, Y, La or mixture thereof). Likewise, the barrier layer is typically included to prevent elements of one layer from diffusing into another layer. In one example, the barrier layer comprising a cermet combination of nickel and metal oxide is applied to the fuel electrode.

While the invention has been described in detail in connection with only a limited number of embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A backbone-structured metal supported electrochemical cell comprising a layered configuration of the following components:
(a) an oxygen electrode,
(b) an electrolyte,
(c) a fuel electrode,
(d) a porous metal substrate disposed in a layer defining a first side and a second side and having a porosity ranging from 20 volume percent to 50 volume percent; and
(e) a densified metal reinforcement member disposed along at least a portion of a perimeter of the second side of the porous metal substrate, opposite the first side adjacent the fuel electrode.

2. The backbone-structured metal-supported electrochemical cell according to claim 1 wherein the porous metal substrate comprises pores ranging in size from 3 microns to 75 microns.

3. The backbone-structured metal-supported electrochemical cell according to claim 1 wherein the densified metal reinforcement member has a porosity of less than 20 volume percent.

4. The backbone-structured metal-supported electrochemical cell according to claim 1 wherein the porous metal substrate has a thickness ranging from 80 microns to 1,000 microns; and wherein the densified metal reinforcement member has a thickness ranging from 50 microns to 1,000 microns.

5. The backbone-structured metal-supported electrochemical cell according to claim 1 wherein the porous metal substrate and the densified reinforcement member are each independently selected from the group consisting of iron-chromium alloys, iron-nickel-chromium alloys, iron-cobalt alloys, iron-aluminum-chromium alloys, and chromium alloys.

6. The backbone-structured metal-supported electrochemical cell according to claim 1 further comprising an interlayer disposed in between (a) the oxygen electrode and (b) the electrolyte.

7. The backbone-structured metal-supported electrochemical cell according to claim 1 further comprising a barrier layer disposed in between (c) the fuel electrode and (d) the porous metal substrate.

8. The backbone-structured metal-supported electrochemical cell according to claim 1 further comprising an additional layer (f) comprising a metal frame coupled to the densified metal reinforcement member.

9. The backbone-structured metal-supported electrochemical cell according to claim 8 further comprising an additional layer (g) comprising an interconnect coupled to the metal frame of additional layer (f).

10. The backbone-structured metal-supported electrochemical cell according to claim 9 wherein the interconnect further comprises one or more fuel gas flow channels disposed on a first side adjacent the metal frame, and one or more air or oxygen flow channels on a second side of the interconnect, opposite the first side.

11. An electrochemical cell stack comprising a plurality of the backbone-structured metal-supported electrochemical cells of claim 1.

12. The electrochemical cell stack of claim 11 wherein each backbone-structured metal-supported electrochemical cell is a metal-supported solid oxide fuel cell or a metal-supported solid oxide electrolysis cell.

13. A reinforced porous metal substrate for use in an electrochemical cell, comprising: (a) a porous metal substrate configured as a layer defining a first side and a second side and having a porosity ranging from 20 volume percent to 50 volume percent; and (b) a densified metal reinforcement member disposed along at least a portion of a perimeter of one side of the porous metal substrate.

14. The reinforced porous metal substrate according to claim 13 wherein the porous metal substrate of (a) comprises pores ranging in size from 3 microns to 75 microns, and the densified metal reinforcement member of (b) has a porosity less than 20 volume percent.

15. (canceled)

16. The reinforced porous metal substrate according to claim 13 wherein the porous metal substrate of (a) has a thickness ranging from 80 microns to 1,000 microns; and wherein the densified reinforcement member of (b) has a thickness ranging from 50 microns to 1,000 microns.

17. The reinforced porous metal substrate according to claim 13 wherein the porous metal substrate of (a) and the densified reinforcement member of (b) are each independently selected from the group consisting of iron-chromium alloys, iron-nickel-chromium alloys, iron-cobalt alloys, iron-aluminum-chromium alloys, and chromium alloys.

18. (canceled)

19. The reinforced porous metal substrate according to claim 13 wherein the densified metal reinforcement member additionally comprises one or more metal struts.

20. The reinforced porous metal substrate according to claim 13 wherein the densified metal reinforcement member is disposed along the entire perimeter of the porous metal substrate (a), or disposed along two parallel edges of the porous metal substrate (a), or disposed at the four corners of the porous metal substrate (a).

21. (canceled)

22. A method of making the reinforced porous metal substrate of claim 13 comprising:
(a) screen printing a metal reinforcement ink along at least a portion of a perimeter of one side of a layer of a porous metal substrate having a porosity ranging from 20 to 50 volume percent so as to form a substrate-ink composite;
(b) sintering the substrate-ink composite under conditions sufficient to form a metal reinforcement member, so as to obtain the reinforced porous metal substrate configured as a layer defining a first side and a second side, and having a porosity ranging from 20 volume percent to 50 volume percent and having disposed along at least a portion of a perimeter of one side thereof the densified metal reinforcement member.

23.-25. (canceled)

26. The method in accordance with claim 22 wherein the metal reinforcement ink comprises a solvent, a binder, a plasticizer, and particles of a reinforcement metal ranging in size from 5 microns to 25 microns.

27. The method in accordance with claim 22 wherein the sintering is conducted at a temperature between 900° C. and 1300° C. under a reducing atmosphere comprising hydrogen.

28. A method of making the reinforced porous metal substrate of claim 13 comprising:
(a) obtaining a green metal sheet comprising substrate metal particles and a pore former capable of providing a porosity ranging from 20 to 50 volume percent; and obtaining a green metal reinforcement member comprising metal particles capable of producing a densified reinforcement member;
(b) hot pressing the green reinforcement member onto at least a portion of a perimeter of one side of the green metal sheet to form a laminated structure;
(c) heating the laminated structure at a temperature and pressure sufficient to prepare the reinforced porous metal substrate configured as a layer defining a first side and a second side and having a porosity ranging from 20 to 50 volume percent, and having disposed along at least portion of a perimeter on one side thereof the densified metal reinforcement member.

29. The method in accordance with claim 28 wherein the hot pressing of step (b) is conducted at a pressure ranging from 206.8 kPa to about 3,447 kPa at a temperature ranging from 50° C. to 150° C., and wherein the heating of step (c) is conducted under a reducing atmosphere at a temperature between 900° C. and 1300° C.

30.-33. (canceled)
